(19) United States
(12) Patent Application Publication
(10) Pub. No.: US 2026/0103047 A1
(43) Pub. Date: Apr. 16, 2026

(54) VEHICLE VENTILATION APPARATUS AND VEHICLE

(71) Applicant: KAWASAKI MOTORS, LTD., Akashi-Shi (JP)

(72) Inventors: Tyler ARTER, Lincoln, NE (US); Brian BUTLER, Lincoln, NE (US)

(73) Assignee: KAWASAKI MOTORS, LTD., Akashi-Shi (JP)

(21) Appl. No.: 18/915,575

(22) Filed: Oct. 15, 2024

(51) Int. Cl. B60H 1/26; B60H 1/24

(52) U.S. Cl. CPC B60H 1/267; B60H 1/242

(57) ABSTRACT

A vehicle ventilation apparatus is attached to a panel member including a ventilation port. The vehicle ventilation apparatus includes a support member fixed around the ventilation port of the panel member and a flap supported by the support member in an angularly displaceable form. The flap is angularly displaced with respect to the support member, thus can change a posture between a close posture of closing the ventilation port and an open posture of opening the ventilation port. The support member includes a first support part rotatably supporting a first part of the flap, a second support part rotatably supporting a second part of the flap, and a protrusion part protruding to one side along a passage direction of the ventilation port.

### BACKGROUND OF THE INVENTION

### Technical Field

The present disclosure relates to a vehicle ventilation apparatus and a vehicle.

### Background Art

U.S. Pat. No. 10,596,888B2 discloses a technique of opening and closing a ventilation port of a vehicle.

### SUMMARY

A vehicle ventilation apparatus is a vehicle ventilation apparatus attached to a panel member including a ventilation port, including: a support member fixed around the ventilation port of the panel member; and a flap supported by the support member in an angularly displaceable form, wherein the flap is angularly displaced with respect to the support member, thus can change a posture between a close posture of closing the ventilation port and an open posture of opening the ventilation port, and the support member includes a first support part rotatably supporting a first part of the flap, a second support part rotatably supporting a second part of the flap, and a protrusion part protruding to one side along a passage direction of the ventilation port.

According to the vehicle ventilation apparatus, the protrusion part prevents rainwater streaming down the panel member from being directed to the ventilation port. Accordingly, even when a gap is formed between the flap and the panel member, ingress of rainwater inside a vehicle through the gap can be suppressed.

The objects, features, aspects, and advantages of this disclosure will become more apparent from the following detailed description and the accompanying diagrams.

### BRIEF DESCRIPTION OF DRAWINGS

FIG. 1 is a side view illustrating a vehicle including a vehicle ventilation apparatus.

FIG. 2 is a diagram seen from an arrow A1 in FIG. 1.

FIG. 3 is a perspective view illustrating the vehicle ventilation apparatus.

FIG. 4 is an exploded perspective view illustrating the vehicle ventilation apparatus.

FIG. 5 is a front view illustrating the vehicle ventilation apparatus.

FIG. 6 is a back view illustrating the vehicle ventilation apparatus.

FIG. 7 is a bottom view illustrating the vehicle ventilation apparatus.

FIG. 8 is a side view illustrating the vehicle ventilation apparatus.

FIG. 9 is an exploded perspective view of flap, a support member, and an inner member.

FIG. 10 is a cross-sectional view along an X-X line in FIG. 5.

FIG. 11 is a cross-sectional view along an XI-XI line in FIG. 5.

FIG. 12 is an enlarged view of a region R1 in FIG. 11.

FIG. 13 is a cross-sectional view along an XIII-XIII line in FIG. 5.

FIG. 14 is a diagram explaining an example of a flow of rainwater while a flap is in a close posture.

FIG. 15 is a diagram explaining an example of a flow of traveling wind while the flap is in a first open posture.

FIG. 16 is a diagram explaining an example of a flow of traveling wind while the flap is in a second open posture.

FIG. 17 is a diagram explaining an example of a flow of traveling wind while the flap is in a third open posture.

### DESCRIPTION OF THE PREFERRED EMBODIMENTS

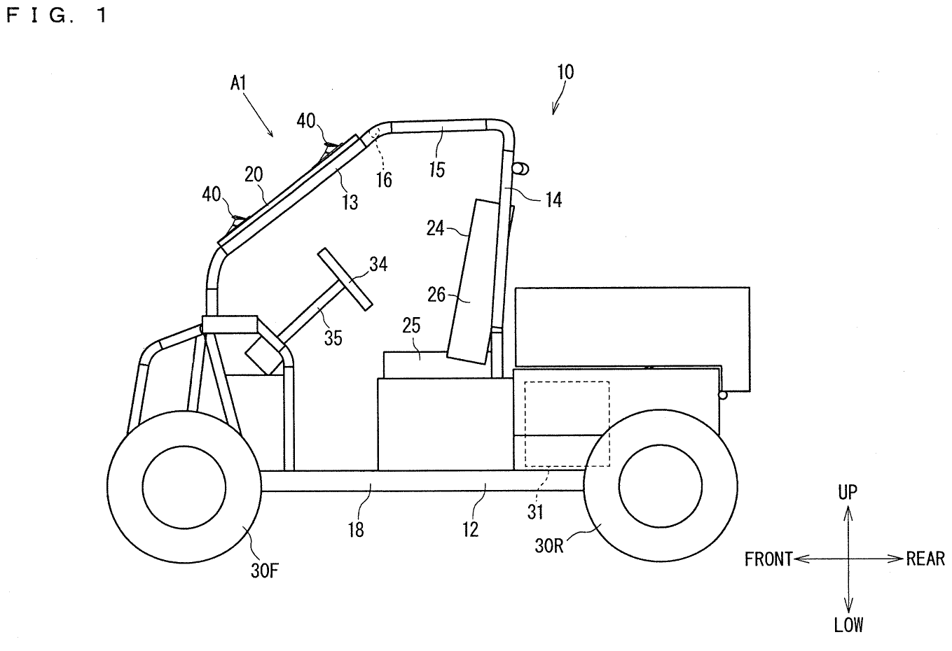

Described hereinafter are a vehicle ventilation apparatus and a vehicle according to an embodiment. FIG. 1 is a side view illustrating a vehicle 10 including a vehicle ventilation apparatus 40. In the following description, a travel direction of the vehicle 10 may be expressed as FRONT, a direction opposite to the travel direction may be expressed as REAR, a road surface side on which the vehicle 10 travels may be expressed as LOW, and a side opposite to the road surface side may be expressed as UP. The RIGHT-LEFT may be referred to while a person stands on a road surface and faces forward. A right-left direction is a vehicle-width direction.

An occupant capacity of the vehicle 10 may be one, or a plurality of persons may also be applicable. The vehicle 10 may include only one seat in a front-back direction, or may also include a plurality of seats.

Described herein is an example that the vehicle 10 is the wheeled vehicle 10 traveling on the ground. The wheeled vehicle 10 may be an all-terrain vehicle (ATV), a passenger transport vehicle (PTV), or a motorbike. for example. Since the wheeled vehicle 10 is a wheeled vehicle for a purpose of traveling on a driveway or a private road at a low speed, for example, entrances on right and left sides of a seat may be opened without being obstructed by walls or doors so that an occupant can easily get in and out of the vehicle 10. Here, the occupant can walk past in a right-left direction without being obstructed by doors or walls. The vehicle 10 may be other than the wheeled vehicle 10, thus may be a personal water craft (PWC), for example.

### Whole Configuration Of Wheeled Vehicle 10

In the present embodiment, the wheeled vehicle 10 further includes a car body 12, a seat 24, a travel mechanism, and a drive operation mechanism.

The car body 12 may have a frame structure or a monocoque structure. The description in the present embodiment is based on an assumption that the car body 12 has a frame structure. The car body 12 includes a frame member and a panel member.

The frame member is structured by combining, for example, metallic pipe components, sheet metal components, or cast components. The frame member includes an A pillar 13, a B pillar 14, a top frame 15, and a cross frame 16, for example. The A pillar 13 extends in an up-down direction in both right and left sides in front of a seat. The B pillar 14 extends in an up-down direction in both right and left sides in back of a seat. The top frame 15 extends in a front-back direction above both right and left sides. The top frame 15 connects the A pillar 13 and the B pillar 14. The cross frame 16 extends in the right-left direction on an upper side. The cross frame 16 connects right and left frame members.

The panels member covers the frame member or various components supported by the frame member. The panel member constitutes an outer appearance of the wheeled vehicle 10, and partitions spaces in the wheeled vehicle 10. A floor panel 18 and a windshield 20, for example, are provided as the panel member. The floor panel 18 is located at a bottom of a space for occupants. The windshield 20 is located in front of the space for the occupants. The windshield 20 is disposed in a portion surrounded by the right and left A pillars 13 and the cross frame 16. The windshield 20 is supported by the right and left A pillars 13 or the cross frame 16. Moreover, a roof or a hood, for example, may be provided as a panel member. The roof covers an upper side of the seat 24. The roof can protect the occupant from the sun and rain. The roof is supported by the top frame 15 and the cross frame 16, for example. The hood is provided at a front of the wheeled vehicle 10 and a bottom of the windshield 20.

The seat 24 is a part on which the occupant is to be seated. The seat 24 is located on the floor panel 18. The seat 24 is supported by the car body 12. Herein, only a first seat is provided in the seat 24. The first seat includes a driver seat. The seat may include a second seat in back of the first seat. The seat 24 includes a seat cushion 25 and a backrest cushion 26. An opening part surrounded by the A pillar 13, the B pillar 14, and the top frame 15 is provided to outer right and left sides of the seat 24. The opening part is an opening part through which the occupant gets in and out of the wheeled vehicle 10. The wheeled vehicle 10 is intended to normally travel with the opening part being opened and not closed by, for example, a door.

In the present embodiment, the seat 24 is a bench seat on which persons are seated side by side in a vehicle width direction. A driver seat on one side in the vehicle width direction and a passenger seat on the other side in the vehicle width direction are disposed with a center in the vehicle width direction therebetween. The seat 24 may have a configuration that a driver seat and a passenger seat are provided independently from each other.

The travel mechanism is a mechanism for the wheeled vehicle 10 to travel, and includes wheels 30F and 30R, a travel motor 31, and a power transmission mechanism. Transmission of rotation drive force of the travel motor 31 to the wheels 30F and 30R through the power transmission mechanism allows the wheeled vehicle 10 to travel. Described in the present embodiment is an example that the wheeled vehicle 10 includes four wheels 30F and 30R. The wheeled vehicle 10 may include three wheels, or may also include six wheels. The configuration of the power transmission mechanism is discretionary. Examples of the power transmission mechanism may include a transmission and a drive shaft.

The wheels 30F and 30R include front wheels 30F and rear wheels 30R. Two front wheels 30F are rotatable around its own central axis and are supported to be rotatable around a steering axis at right and left front portions of the car body 12. The two rear wheels 30R are supported to be rotatable around its own central axis at right and left rear portions of the car body 12.

In the present embodiment, the travel motor 31 is an electrical motor converting electrical energy into rotational motion for traveling. Here, the wheeled vehicle 10 includes a travel battery for supplying the electrical energy to the travel motor 31. For example, it is applicable that the travel battery is supported at a lower portion of the first seat, and the travel motor 31 is supported at a lower portion of a cargo bed. The travel motor 31 may be an internal combustion engine which burns fuel in a combustion chamber and generates power for traveling through expansion of gases from the burnt fuel. In this case, it is sufficient that the wheeled vehicle 10 includes a fuel tank. The positions of the travel motor 31 and the travel battery are discretionary.

The drive operation mechanism is a mechanism for receiving a drive operation of a driver, and includes a steering wheel 34 and a pedal, for example. The driver operates the steering wheel 34, thereby being able to rotate the front wheels 30F around the steering axis. The driver operates the pedal, thereby being able to perform an acceleration operation and a brake operation. The steering wheel 34 and the pedal are located in front of the seat 24. The driver seated on the seat 24 can operate the steering wheel 34 and the pedal. A steering column 35 protrudes backward from a dashboard, and the steering wheel 34 is supported on a tip end of the steering column 35, for example. The pedal is located below the steering wheel. The pedal may be an accelerator pedal and a brake pedal which are separately provided. It is applicable that both the acceleration and the brake can be operated with one pedal.

In the wheeled vehicle 10, the vehicle ventilation apparatus 40 (simply referred to as the ventilation apparatus 40 hereinafter) is attached to the panel member. The panel member to which the ventilation apparatus 40 is attached is a panel member covering an occupant cabin, for example. Described herein is an example that the ventilation apparatus 40 is attached to the windshield 20 located in front of the occupant cabin. The ventilation apparatus 40 may be attached to a windshield located on a lateral side or a back side of the occupant cabin. The ventilation apparatus 40 may be attached to a panel member other than the windshield 20 such as a roof, for example. The number of the ventilation apparatuses 40 and positions thereof attached to the panel member are discretionary. The number of the ventilation apparatuses 40 attached to one panel member may be one, or plurality of the ventilation apparatuses 40 are also applicable. When the ventilation apparatuses 40 are attached one panel member, the ventilation apparatuses 40 may have the same structure as each other or structures different from each other.

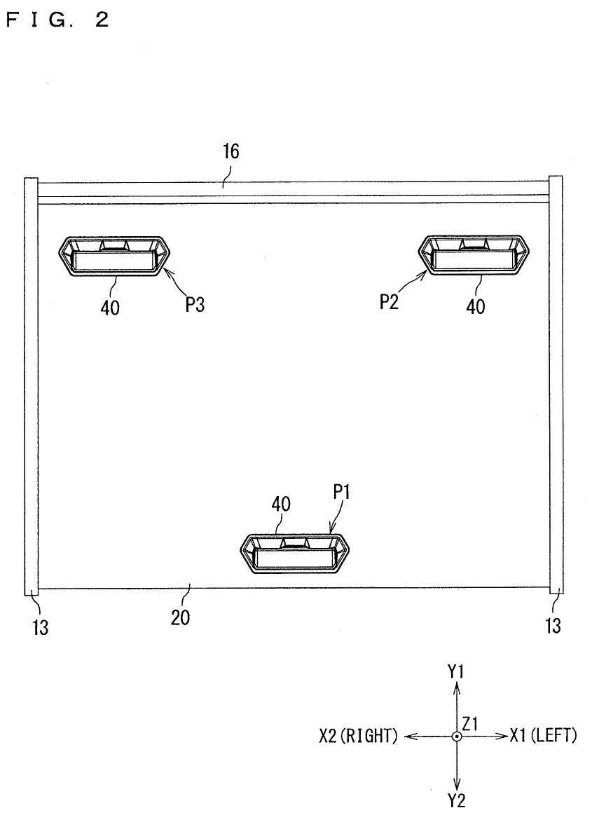

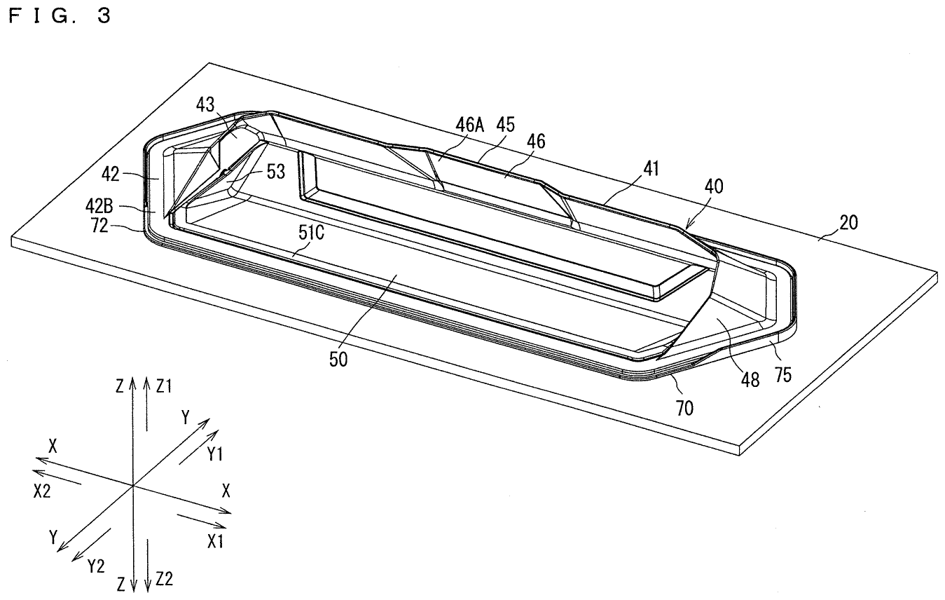

FIG. 2 is a diagram seen from an arrow A1 in FIG. 1. The arrow A1 is directed along a thickness direction of the windshield 20. The windshield 20 is formed into a transparent plate-like shape. In the wheeled vehicle 10, the windshield 20 has a posture in which the thickness direction intersects with each of the front-back direction and the up-down direction. A direction along the thickness direction of the windshield 20 is a Z direction hereinafter. In a planar surface perpendicular to the Z direction, two directions perpendicular to each other are an X direction and a Y direction, respectively. Herein, the X direction is a direction along the right-left direction of the wheeled vehicle 10. A left direction of the wheeled vehicle 10 in the X direction is an X1 direction, and an opposite direction thereof is an X2 direction. A direction directed to an upper side and a back side from the windshield 20 in the Y direction is a Y1 direction, and an opposite direction thereof is a Y2 direction. A direction directed to an outer side of the wheeled vehicle 10 from the windshield 20 in the Z direction is a Z1 direction, and an opposite direction thereof is a Z2 direction (refer to FIG. 3).

In the example illustrated in FIG. 2, three ventilation apparatuses 40 are attached to one windshield 20. Positions of three ventilation apparatuses 40 are a first position P1, a second position P2, and a third position P3, respectively. The first position P1 is a position on a lower side in the up-down direction and a center in the right-left direction in the windshield 20. The second position P2 is a position on an upper side in the up-down direction and a left side in the right-left direction in the windshield 20. The third position P3 is a position on the upper side in the up-down direction and a right side in the right-left direction in the windshield 20. Three ventilation apparatuses 40 may be located in the other positions.

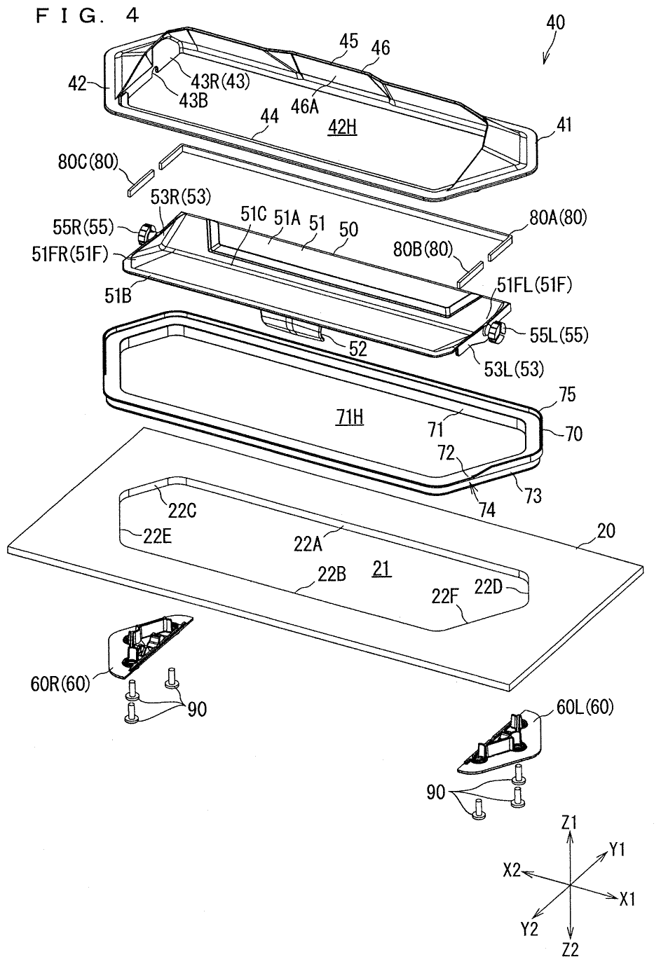

A ventilation port 21 (refer to FIG. 4) is formed in positions corresponding to the first position PI, the second position P2, and the third position P3, respectively, in the windshield 20. The ventilation apparatus 40 is attached to each ventilation port 21.

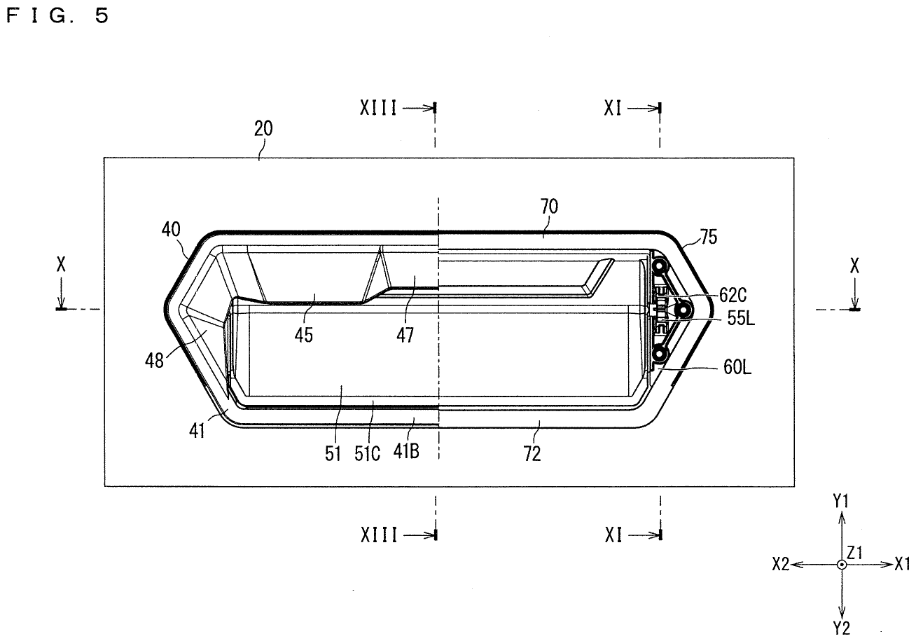

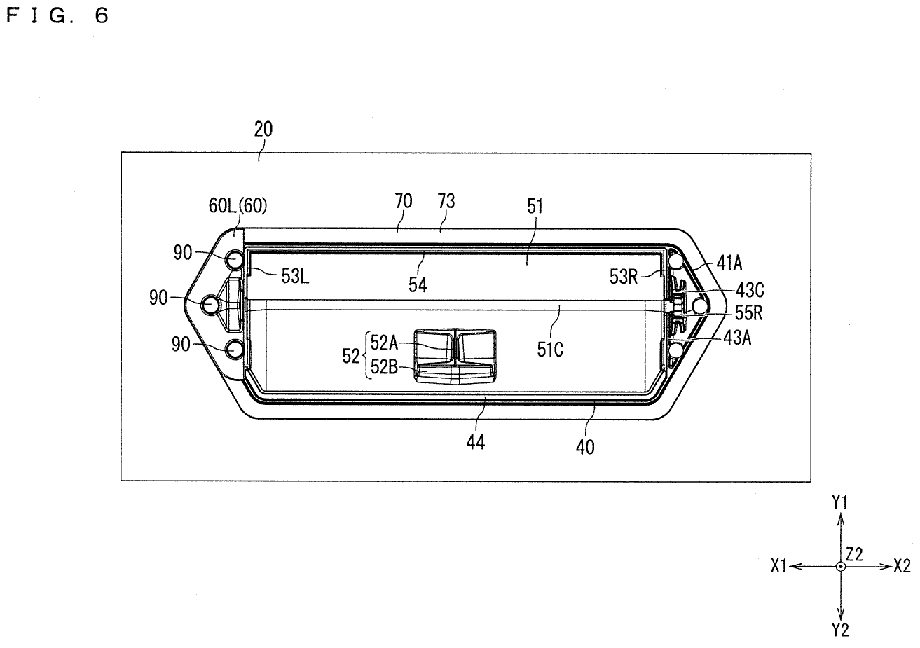

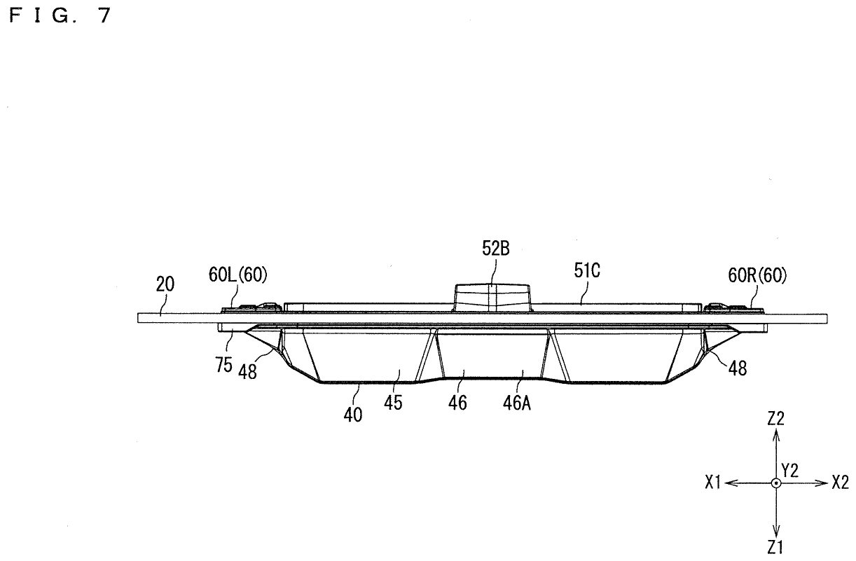

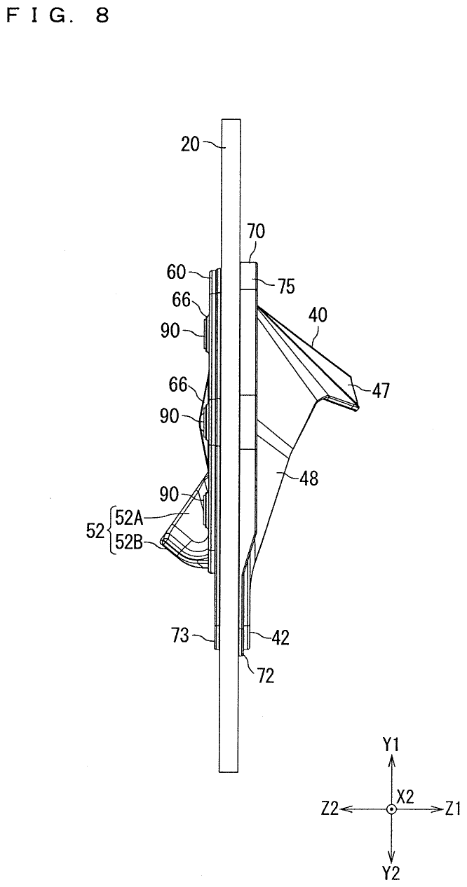

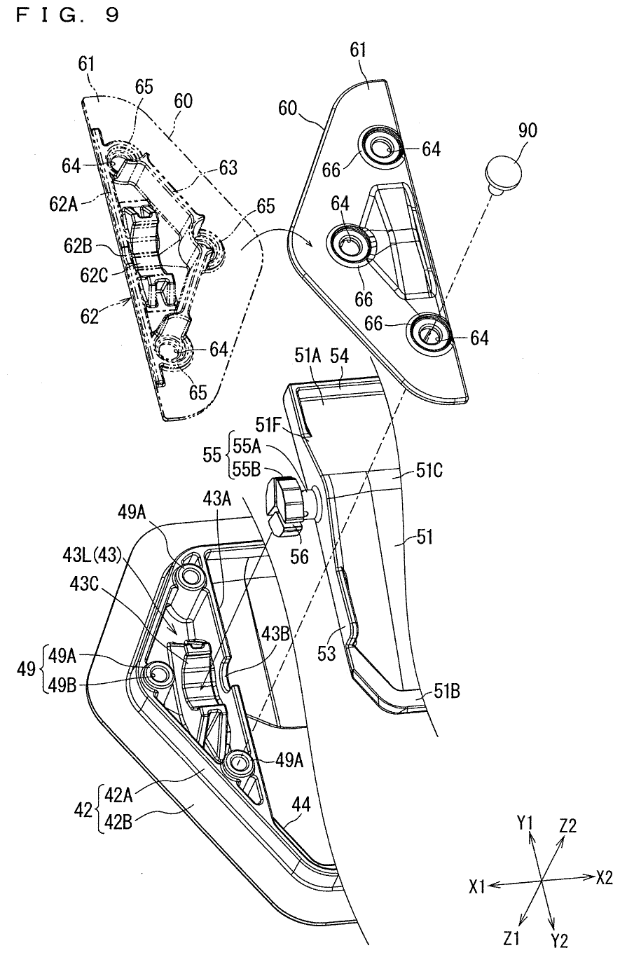

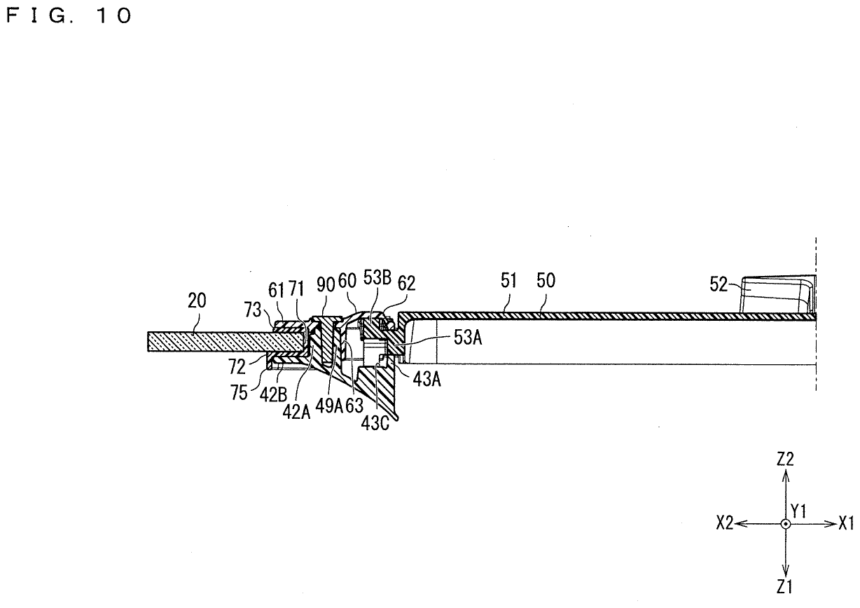

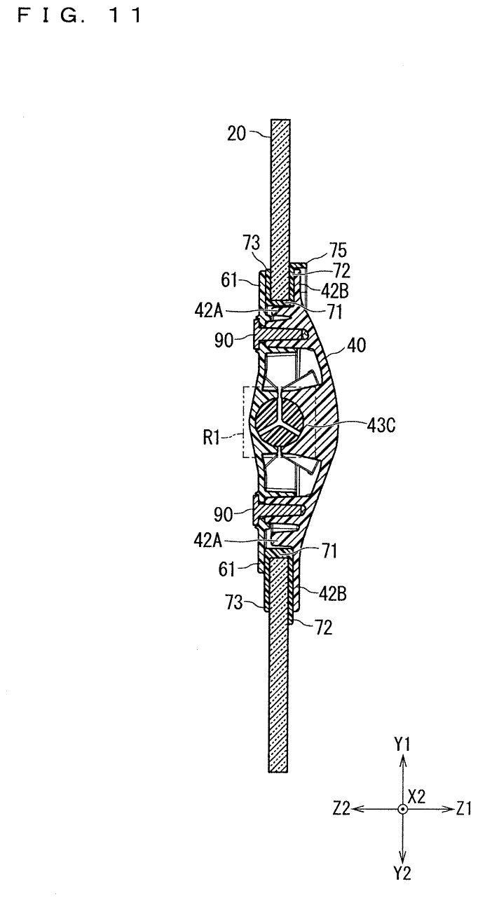

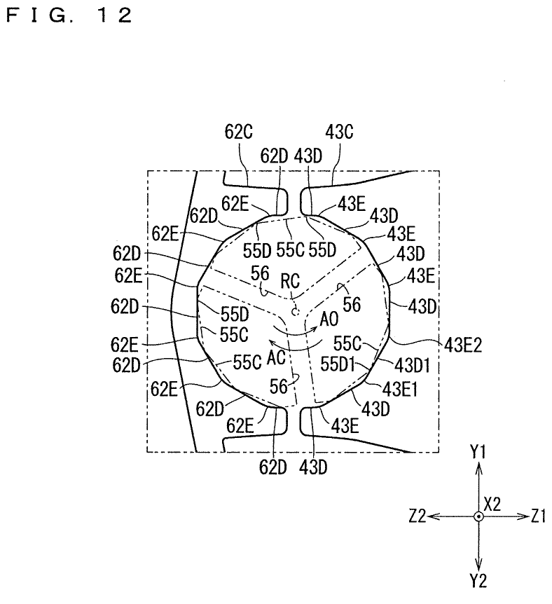

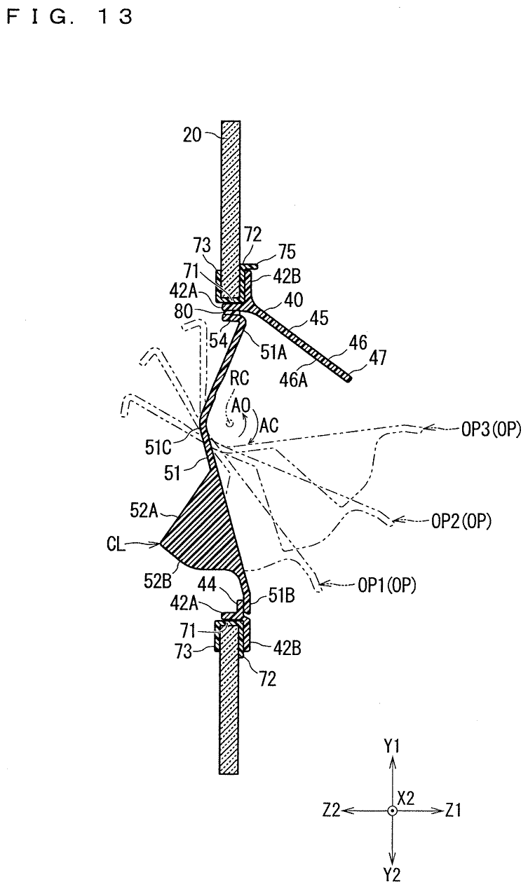

One ventilation apparatus 40 is described in more detail hereinafter with reference to FIG. 3 to FIG. 13. FIG. 3 is a perspective view illustrating the ventilation apparatus 40. FIG. 4 is an exploded perspective view illustrating the ventilation apparatus 40. FIG. 5 is a front view illustrating the ventilation apparatus 40. FIG. 6 is a back view illustrating the ventilation apparatus 40. FIG. 7 is a bottom view illustrating the ventilation apparatus 40. FIG. 8 is a side view illustrating the ventilation apparatus 40. FIG. 9 is an exploded perspective view of a flap 50, a support member 41, and an inner member 60. FIG. 10 is a cross-sectional view along an X-X line in FIG. 5. FIG. 11 is a cross-sectional view along an XI-XI line in FIG. 5. FIG. 12 is an enlarged view of a region R1 in FIG. 11. FIG. 13 is an end view along an XIII-XIII line in FIG. 5. FIG. 5 illustrates a state with the support member 41 in a left portion with respect to a center line and a state without the support member 41 in a right portion with respect to the center line in the ventilation apparatus 40. In FIG. 6, one inner member 60 is omitted. In FIG. 9, the inner member 60 shown by a virtual line indicates the actual inner member 60 rotated around an axis along the Y direction at 180 degrees. In FIG. 13, the flap 50 shown by a solid line has a close posture CL, and the flap 50 shown by a virtual line has an open posture. The close posture CL may not completely cover the ventilation port 21. The close posture CL may be a posture closing the ventilation port 21 with a largest degree in postures of the flap 50.

The windshield 20 is formed of glass or transparent resin as a material, for example. The transparent resin is polycarbonate or acrylic resin, for example. The ventilation port 21 in the windshield 20 passes through the windshield 20 in the thickness direction. The ventilation port 21 is formed in a position where the ventilation apparatus 40 is attached in the windshield 20. As illustrated in FIG. 4, a shape of the ventilation port 21 is a bilaterally symmetric hexagonal shape herein. The windshield 20 includes six edges 22A, 22B, 22C, 22D, 22E, and 22F as a peripheral edge of the ventilation port 21. Two edges 22A and 22B extending in the X direction are longer than the other four edges 22C, 22D, 22E, and 22F in six edges 22A, 22B, 22C, 22D, 22E, and 22F. The ventilation port 21 is longer in the X direction than in the Y direction. The upper edge 22A is longer than the lower edge 22B in two edges 22A and 22B. The upper edges 22C and 22D are shorter than the lower edges 22E and 22F in four edges 22C, 22D, 22E, and 22F. However, the shape of the ventilation port 21 is optionally set, thus may be a quadrangular shape.

The ventilation apparatus 40 can open and close the ventilation port 21. The ventilation apparatus 40 is operated by an occupant, for example. The ventilation apparatus 40 includes the support member 41 and the flap 50. The support member 41 is fixed around the ventilation port 21 in the windshield 20. The flap 50 are supported by the support member 41 in an angularly displaceable form. As illustrated in FIG. 13, the flap 50 is angularly displaced with respect to the support member 41, thus can change a posture between the close posture CL of closing the ventilation port 21 and the open posture OP of opening the ventilation port 21.

Herein, the ventilation apparatus 40 further includes the inner member 60 and a grommet 70. The inner member 60 sandwiches the windshield 20 from an inner side together with the support member 41 disposed on an outer side of the windshield 20. The grommet 70 is fitted into a peripheral edge part of the ventilation port 21. The support member 41, the flap 50, and the inner member 60 are formed by a resin material, for example. The grommet 70 is formed by an elastic material such as rubber, elastomer, or foam resin, for example. The support member 41, the flap 50, the inner member 60, and the grommet 70 are members different from each other, for example. The support member 41, the flap 50, the inner member 60, and the grommet 70 are injection molding components using molds, respectively, for example.

The support member 41 includes a frame part 42, a support part 43, a regulation part 44, a protrusion part 45, and a receiving part 49. In the support member 41, the frame part 42, the support part 43, the regulation part 44, the protrusion part 45, and the receiving part 49 are provided to one member. The protrusion part 45 may be provided to a member different from the support part 43.

The frame part 42 is formed into a frame-like shape extending around the peripheral edge part of the ventilation port 21. The frame part 42 includes a cylindrical part 42A and a flange 42B. The cylindrical part 42A is formed into a cylindrical shape with a hole 42H. The cylindrical part 42A is disposed in an inner part of the ventilation port 21. The cylindrical part 42A is formed into a hexagonal cylindrical shape corresponding to the ventilation port 21. The flange 42B protrudes from an outer end part (an end part in the Z1 direction) to an outer periphery side (a side opposite to the hole 42H) of both ends of the cylindrical part 42A. The frame part 42 may have a shape not extending around the ventilation port 21. For example, the frame part 42 may have a U-like shape such as a water stop wall 75 described hereinafter of the grommet 70. For example, the frame part 42 has a shape made up of two parallel lines such as two inner members 60 provided to both ends of the ventilation port 21.

The support part 43 is a part supporting the flap 50. The support part 43 includes a partition wall 43A, a groove 43B, and a holder 43C. The partition wall 43A connects a part and the other part of the cylindrical part 42A. Herein, the partition wall 43A connects a part of the cylindrical part 42A corresponding to the edge 22A and a part thereof corresponding to the edge 22E (22F). The partition wall 43A partitions a space supporting the flap 50 and a space where a body 51 of the flap 50 is provided. The groove 43B is formed in a tip end of the partition wall 43A in the Z2 direction. The holder 43C is formed in a space surrounded by an end part of the cylindrical part 42A in the X direction and the partition wall 43A. The holder 43C holds a detent 55B of the flap 50. The holder 43C includes a holding surface 43D and a corner part 43E. The support part 43 is provided to both right and left sides. The support part 43 on the left side is a first support part 43L and the support part 43 on the right side is a second support part 43R.

The regulation part 44 is a part regulating an angular displacement of the flap 50. The regulation part 44 protrudes from an inner end part (an end part in the Z2 direction) to an inner periphery side (a side opposite to the flange 42B) of both ends of the cylindrical part 42A. The regulation part 44 is formed in a part corresponding to the edge 22B. Herein, the regulation part 44 is also formed in parts corresponding to the edges 22E and 22F. An end part of the regulation part 44 is connected to the partition wall 43A.

The protrusion part 45 protrudes to one side (the Z1 direction herein) along a passage direction (the Z direction) of the ventilation port 21. The protrusion part 45 is located on an upper part of the windshield 20 with respect to the ventilation port 21. The protrusion part 45 includes a guiding part 46 guiding traveling wind to the ventilation port 21. Formed in the guiding part 46 is an inner surface inclined away from the ventilation port 21 in a direction perpendicular to the travel direction with increasing distance from a portion in proximity to the ventilation port 21 in the travel direction of the vehicle 10. Specifically, formed in the guiding part 46 is an inclined surface 46A directed upward from a portion in proximity to an upper part of the ventilation port 21 toward a front side.

The protrusion part 45 includes an upper surface 47 and a side surface 48. The upper surface 47 extends to a front side from a portion facing the ventilation port 21 in proximity to the upper part of the ventilation port 21. Herein, the upper surface 47 is a surface of the guiding part 46 on a side opposite to the inclined surface 46A. Each side surface 48 extends to a front side from a portion facing the ventilation port 21 in proximity to both side parts of the ventilation port 21.

The receiving part 49 is a part to which a fastening member 90 is fastened. Herein, the receiving part 49 includes at least one boss 49A. A fastening hole 49B is formed in the boss 49A. The fastening member 90 is fastened to the fastening hole 49B. Herein, three bosses 49A are provided to one support part 43. An outer peripheral surface of each of three bosses 49A is connected to the cylindrical part 42A. An outer peripheral surface of each of two bosses 49A is connected to the partition wall 43A.

The flap 50 includes the body 51, a knob 52, a sidewall 53, an upper wall 54, and a shaft part 55.

The body 51 covers the ventilation port 21 in the close posture CL. The body 51 is formed into a quadrangular shape in a plan view. The body 51 includes a first edge part 51A, a second edge part 51B, and an intermediate part 51C. The first edge part 51A is located on a side of the protrusion part 45 in the Y direction. The second edge part 51B is located on a side opposite to the first edge part 51A in the Y direction. The intermediate part 51C is located between the first edge part 51A and the second edge part 51B in the Y direction. The intermediate part 51C protrudes to the other side (the Z2 direction) along the passage direction (the Z direction) more than the first edge part 51A and the second edge part 51B. In the description hereinafter, the intermediate part 51C is the most protruding part in the other side (the Z2 direction) along the passage direction. A part located on a side of the Y1 direction with respect to the intermediate part 51C is a back side part 51D and a part on a side opposite thereto is a front side part 51E. An amount of protrusion of the back side part 51D in the Z2 direction increases from the first edge part 51A toward the intermediate part 51C. An amount of protrusion of the front side part 51E in the Z2 direction increases from the second edge part 51B toward the intermediate part 51C. Herein, the intermediate part 51C is located on a side of the Y1 direction with respect to the center in the Y direction. The front side part 51E is longer than the back side part 51D along the Y direction.

The knob 52 protrudes from the body 51 toward the other side (the Z2 direction) along the passage direction. The knob 52 is located in a center of the body 51 in the X direction. The knob 52 is provided to the front side part 51E. The knob 52 includes a body wall part 52A and a reinforcement wall part 52B. The body wall part 52A extends in the Y direction. The reinforcement wall part 52B is connected to an end part of the body wall part 52A in the Y2 direction. The reinforcement wall part 52B extends from the body wall part 52A to both sides in the X direction. For example, an occupant catches the body wall part 52A with fingers and presses and pulls the body wall part 52A in the Z direction, thereby being able to perform an operation of opening and closing the flap 50. The reinforcement wall part 52B supports the fingers of the occupant catching the body wall part 52A along the Y direction. Accordingly, slip of the fingers of the occupant catching the body wall part 52A in the Y direction away from the body wall part 52A can be suppressed.

The sidewall 53 protrudes from the side edge 51F of the body 51 along the passage direction (the Z direction). The sidewall 53 protrudes from the body 51 in the Z1 direction in the intermediate part 51C and an area around the intermediate part 51C. The sidewall 53 protrudes from the body 51 in the Z2 direction in the first edge part 51A and an area around the first edge part 51A. The sidewall 53 protrudes from the body 51 in the Z2 direction in the second edge part 51B and an area around the second edge part 51B. An outer surface (a surface facing a side opposite to the center along the X direction) of the sidewall 53 is a flat surface.

The side edge 51F and the sidewall 53 are provided on both right and left sides, respectively. The side edge 51F on the left side if a first side edge 51FL, and the side edge 51F on the right side is a second side edge 51FR. The sidewall 53 on the left side is a first sidewall 53L, and the sidewall 53 on the right side is a second sidewall 53R.

The upper wall 54 protrudes from the first edge part 51A to the other side (the Z2 direction) along the passage direction. An outer surface (a surface facing in the Y1 direction) of the upper wall 54 is a flat surface. The upper wall 54 connects the pair of sidewalls 53. An end part of the upper wall 54 in the X direction is connected to the sidewall 53.

The shaft part 55 includes a columnar pillar part 55A and a detent 55B provided to a tip end of the pillar part 55A. The detent 55B is larger than the pillar part 55A when seen from an axial direction (the X direction). The shaft part 55 is supported by the support part 43. The pillar part 55A is housed in a groove 43B and the detent 55B is housed in the holder 43C in the support part 43.

The shaft part 55 is provided to both right and left sides. The shaft part 55 on the left side is a first shaft part 55L and the shaft part 55 on the right side is a second shaft part 55R. The first shaft part 55L protrudes from an outer surface of the first sidewall 53L. The second shaft part 55R protrudes from an outer surface of the second sidewall 53R.

The first shaft part 55L is the first part 55L rotatably supported by the first support part 43L. The second shaft part 55R is the second part 55R rotatably supported by the second support part 43R. The first part 55L is located in a first end part of the body 51 in the X direction. The second part 55R is located in a second end part of the body 51 in the X direction. The knob 52 is located between a first end part and a second end part of the body 51 in the X direction. The first part 55L is located on an outer surface of the first sidewall 53L, and the second part 55R is located on an outer surface of the second sidewall 53R.

The inner members 60 are provided on both right and left sides, respectively. The inner member 60 on the left side is a first inner member 60L, and the inner member 60 on the right side is a second inner member 60R.

The inner member 60 includes a sandwiching part 61, an inner support part 62, and a fitting wall 63. The sandwiching part 61 sandwiches the windshield 20 together with the flange 42B. The inner support part 62 supports the shaft part 55 from an inner side. The fitting wall 63 is fitted into the support part 43. The fitting wall 63 includes a part of the support part 43 extending along the frame part 42 and a part thereof extending along three bosses 49A. A part of the fitting wall 63 extending along the boss 49A is formed into a curved plate-like shape extending along a part of the boss 49A in a circumferential direction. A part of the fitting wall 63 extending along the frame part 42 connects a part thereof extending along the boss 49A. A part of the fitting wall 63 extending along the frame part 42 is formed into a planar plate-like shape. Since the fitting wall 63 is provided, the support member 41 and the inner member 60 can be easily positioned. Since the fitting wall 63 is provided, rigidity of the inner member 60 can be increased, and force of detent 55B pressing the inner support part 62 in rotation of the shaft part 55 can be easily received.

A through hole 64 is formed in the inner member 60. The through hole 64 passes through the inner member 60 in the Z direction. The through hole 64 is a hole through which the fastening member 90 passes. As illustrated in FIG. 9, ridges 65 and 66 are provided on an outer surface (a surface in the Z1 direction) and an inner surface (a surface of the Z2 direction) of the inner member 60 to surround the through hole 64. Since the ridge 65 on the outer surface is provided, a concave part into which a tip end of the boss 49A is fitted is formed in the outer surface of the inner member 60. Accordingly, the support member 41 and the inner member 60 are easily positioned in a state before the fastening member 90 is fastened. Since the ridge 66 on the inner surface is provided, a concave part into which a head of the fastening member 90 is fitted is formed in the inner surface of the inner member 60. Accordingly, a position where the fastening member 90 is fastened can be easily recognized in the inner member 60. The ridge 65 on the outer surface is continuously formed with the fitting wall 63. The ridge 65 is provided partially around the through hole 64, and the fitting wall 63 is provided to the other part thereof.

The inner support part 62 includes a rib 62A, a groove 62B, and a holder 62C. The rib 62A is formed in a position facing the partition wall 43A. The ridge 65 is also continuously formed with the rib 62A. The groove 62B is formed in a position corresponding to the groove 43B. The pillar part 55A is housed in the groove 62B. The holder 62C holds the detent 55B of the flap 50. The holder 62C includes the holding surface 62D and the corner part 62E.

The grommet 70 includes a cylindrical part 71, an outer flange 72, an inner flange 73, and a water stop wall 75. The grommet 70 includes a groove 74 into which a peripheral edge of the panel is fitted in an outer peripheral surface.

The cylindrical part 71 is formed into a cylindrical shape with a hole 71H. A cylindrical part 41A of the support member 41 is located in an inner part of the hole 71H. A cylindrical part 42A of the support member 41 is fitted into the cylindrical part 71 of the grommet 70; thus, the support member 41 is positioned in the grommet 70. The cylindrical part 71 is disposed in an inner part of the ventilation port 21. The cylindrical part 71 is formed into a hexagonal cylindrical shape corresponding to the ventilation port 21. The outer flange 72 protrudes from an outer end part (an end part in the Z1 direction) to an outer periphery side of the cylindrical part 71. The inner flange 73 protrudes from an inner end part (an end part in the Z2 direction) to an outer periphery side of the cylindrical part 71. A part surrounded by the outer flange 72, the inner flange 73, and the cylindrical part 71 constitutes the groove 74 into which the peripheral edge part of the ventilation port 21 is fitted. The outer flange 72 and the inner flange 73 constitute the a sidewall part of the groove 74, and the cylindrical part 71 constitutes a bottom wall part of the groove 74. An outer peripheral surface of the cylindrical part 42A of the support member 41 and an inner peripheral surface of the cylindrical part 71 of the grommet 70 face each other. An outer peripheral surface of the cylindrical part 71 of the grommet 70 and an inner peripheral surface of the ventilation port 21 of the windshield 20 face each other.

The water stop wall 75 protrudes from an outer edge of the outer flange 72 in the Z1 direction. The water stop wall 75 is provided to portions corresponding to the edges 22A, 22B, 22C, 22D, and 22E. The water stop wall 75 is not provided to a portion corresponding to the edge 22F. The water stop wall 75 is formed into a C-like shape or a U-like shape. The support member 41 is fitted into an inner side of the water stop wall 75.

The windshield 20 and the support member 41 sandwich the grommet 70. An inner surface (a surface directed to the Z2 direction) of the flange 42B of the support member 41 has contact with an outer surface (a surface directed to the Z1 direction) of the outer flange 72 of the grommet 70. An inner surface (a surface directed to the Z2 direction) of the outer flange 72 of the grommet 70 has contact with an outer surface (a surface directed to the Z1 direction) of the windshield 20.

The windshield 20 and the inner member 60 sandwich the grommet 70. An outer surface (a surface directed to the Z1 direction) of the sandwiching part 61 of the inner member 60 has contact with an inner surface (a surface directed to the Z2 direction) of the inner flange 73 of the grommet 70. An outer surface (a surface directed to the Z1 direction) of the inner flange 73 of the grommet 70 has contact with an inner surface (a surface directed to the Z2 direction) of the windshield 20.

As illustrated in FIG. 11, a sidewall part (the outer flange 72 and the inner flange 73) of the groove 74 of the grommet 70 is sandwiched between the windshield 20 and the support member 41 or the inner member 60 in a portion where the inner member 60 is provided. As illustrated in FIG. 13, a whole inner surface of the inner flange 73 of the grommet 70 is exposed to a vehicle interior in a portion where the inner member 60 is not provided.

The inner member 60 includes a first inner support part 62L sandwiching the first part 55L between the first inner support part 62L and the first support part 43L and a second inner support part 62R sandwiching the second part 55R between the second inner support part 62R and the second support part 43R. The first support part 43L and the second support part 43R are provided to one support member 41. The first inner support part 62L is provided to the first inner member 60L, and the second inner support part 62R is provided to the second inner member 60R.

As illustrated in FIG. 13, the flap 50 in the close posture CL is rotated around a rotational center RC in a direction of an arrow AO, thereby having the open posture OP. The flap 50 in the open posture OP is rotated in a direction of an arrow AC, thereby having the close posture CL. The rotational center RC is a center of the shaft part 55 seen from the axial direction (the X direction), for example. Herein, the rotational center RC is located in the same position as a center in the thickness direction of the windshield 20 in the Z direction. The rotational center RC may be located in a position different from the center in the thickness direction of the windshield 20 in the Z direction.

A group of the first part 55L and the first support part 43L or a group of the second part 55R and the second support part 43R has an adjustment structure in which the open posture OP is adjusted to an optional posture in the postures. Herein, the shaft part 55 has the adjustment structure. A slit 56 is formed along a direction intersecting with the axial direction in the shaft part 55.

As illustrated in FIG. 13, the open posture OP can be selected from three postures herein. The posture of the flap 50 is selected from four postures in total including one close posture CL and three open postures OP. As illustrated in FIG. 13, three open postures OP include, in an order of increasing distance to the close posture CL, a first open posture OP1, a second open posture OP2, and a third open posture OP3.

Herein, the detent 55B in a tip end part of the shaft part 55 is formed into a regular dodecagonal pillar shape. The detent 55B includes twelve side surfaces 55C and twelve corner parts 55D. Twelve side surfaces 55C and twelve corner parts 55D are alternately and continuously formed along a circumferential direction. The detent 55B is sandwiched by the holders 43C and 62C. The holders 43C and 62C serve as a clamp sandwiching the detent 55B. The corresponding holders 43C and 62C are formed into a regular dodecagonal cylindrical shape. When the side surface 55C of the detent 55B and the holding surfaces 43D and 62D face each other, the stable open posture OP is achieved. Accordingly, the postures are switched by basically rotating the shaft part 55 by a predetermined angle (herein, 30 degrees corresponding to the regular dodecagon) corresponding to the shape of the shaft part 55.

The flap 50 in the close posture CL can be rotated only in one direction (the direction of the arrow AO) around the axial direction. In the close posture CL, rotation of the flap 50 in the other direction (the direction of the arrow AC) is regulated. Herein, in the close posture CL, an inner surface (a surface in the Z2 direction) of the second edge part 51B of the flap 50 has contact with an outer surface (a surface in the Z1 direction) of the regulation part 44 of the support member 41; thus, the rotation of the flap 50 in the close posture CL in the other direction (the direction of the arrow AC) is regulated.

Herein, the posture can be changed from the close posture CL to the third open posture OP3. If the flap 50 is to be further rotated in the direction of the arrow AO from the third open posture OP3, the body 51 of the flap 50 causes interference with the protrusion part 45 before being rotated at a predetermined angle (30 degrees herein). Accordingly, the flap 50 reaching the fourth open posture is regulated.

The side surface 55C of the detent 55B and the holding surfaces 43D and 62D are formed to have substantially the same size. When the detent 55B is rotated, the detent 55B is elastically deformed to be reduced in size toward the center in the axial direction; thus, the corner part 55D can pass over the holding surfaces 43D and 62D. Herein, the slit 56 is formed in the detent 55B; thus, the detent 55B is elastically deformed easily to be reduced in size toward the center in the axial direction.

Herein, three slits 56 are formed in one detent 55B. Three slits 56 extend in directions intersecting with each other at 120 degrees from the rotational center RC. Each slit 56 reaches the side surface 55C from the rotational center RC when seen from the X direction. The slit 56 extends to a tip end of the detent 55B to a base end thereof along the X direction. Herein, the slit 56 reaches a tip end of the pillar part 55A along the X direction. Herein, the detent 55B has a shape of being divided into three blocks by three slits 56. The side surface 55C including the slit 56 is divided into the adjacent blocks.

The corner part 55D of the detent 55B is elastically deformed so that the detent 55B gets smallest when the detent 55B is located in the center of the holding surfaces 43D and 62D. When the corner part 55D of the detent 55B is located in a position closer to any one of the corner parts 43E and 62E on both sides of the holding surfaces 43D and 62D than the position described above, the flap 50 is biased toward the directions where the corner parts 43E and 62E are located by restoring force of the detent 55B returning to have the original size.

The side surface 55C of the detent 55B and the holding surfaces 43D and 62D of the holders 43C and 62C are offset so that restoring force (biasing force) in the direction of the arrow AC is applied to the flap 50 in the close posture CL. An amount of the offset is for an angle smaller than 15 degrees (for example, substantially 5 to 10 degrees).

More specifically, a corner part 43E1 of the holder 43C is a corner part where a corner part 55D1 of the detent 55B is to be located in the close posture CL in FIG. 12. A corner part 43E2 of the holder 43C is a corner part where a corner part 55D1 of the detent 55B is to be located in the first open posture OP1 next to the close posture CL. A holding surface 43D1 of the holder 43C is a holding surface between the corner parts 43E1 and 43E2, and is a holding surface which the corner part 55D1 is to pass over when the posture is changed from the close posture CL to the first open posture OP1. In the close posture CL, the corner part 55D1 is located between a center of the holding surface 43D1 and the corner part 43E1. Accordingly, biasing force in a direction in which the corner part 55D1 is directed to the corner part 43E1, that is to say, the direction of the arrow AC is applied to the flap 50. Accordingly, the close posture CL of the flap 50 is stably kept easily. The second edge part 51B of the flap 50 is easily kept to have contact with the regulation part 44.

The protrusion part 45 extends along an edge part of the ventilation port 21 on a side of predetermined one direction. The protrusion part 45 protrudes from the windshield 20 to an outer side in the thickness direction (the Z1 direction). The protrusion part 45 covers an upper edge part of the ventilation port 21 from an upper side.

The first inner member 60L and the second inner member 60R are formed to be rotationally symmetric around an axis along the Z direction. Accordingly, the same type of inner member 60 can be used as the first inner member 60L and the second inner member 60R, and increase of the number of types of components can be suppressed. The first inner member 60L and the second inner member 60R are line-symmetric with respect to a line along the X direction when seen from the Z direction. The line is a line passing through a center of the through hole 64 located in a middle in three through holes 64 in the Y direction. The first inner member 60L and the second inner member 60R have a relationship such as a mirror image. They have a relationship of mirror image symmetry.

The ventilation apparatus 40 further includes a seal member 80. The seal member 80 is formed by an elastic material such as rubber, elastomer, or foam resin, for example. The seal member 80 intervenes between the flap 50 and the support member 41 on a side of the center of the ventilation port 21 with respect to the grommet 70. Accordingly, water hardly enters a vehicle interior from between the flap 50 and the support member 41. The seal member 80 is located between a surface of the flap 50 facing an outer peripheral side and a surface of the support member 41 facing an inner peripheral side along a direction intersecting with the passage direction. The seal member 80 is compressed and deformed when being sandwiched between the flap 50 and the support member 41.

In the support member 41, an inner surface (a surface on a side of the hole 42H) of each of the cylindrical part 42A and the partition wall 43A faces an outer surface of the seal member 80. In the flap 50, each of an outer surface (a surface in the X1 direction) of the first sidewall 53L, an outer surface (a surface in the X2 direction) of the second sidewall 53R, and an outer surface (a surface in the Y1 direction) of the upper wall 54 has contact with an inner surface of the seal member 80. The seal member 80 is fixed to any one of the flap 50 and the support member 41. Herein, the seal member 80 is fixed to the support member 41. The seal member 80 may be fixed by bonding, for example.

Herein, the seal member 80 is disconnected at the shaft part 55. Three seal members 80A, 80B, and 80C are provided as the seal member 80. The seal member 80A is formed into a U-like shape. The seal members 80B and 80C are formed straight. The seal member 80A has contact with an outer surface of the upper wall 54 and a part of both sidewalls 53L and 53R on a side of the Y1 direction with respect to the groove 43B. The seal member 80B has contact with a part of the first sidewall 53L on a side of the Y2 direction with respect to the groove 43B. The seal member 80C has contact with a part of the second sidewall 53R on a side of the Y2 direction with respect to the groove 43B. The seal member 80 may be provided as one member so as not to be disconnected at the shaft part 55.

The seal member 80 is not provided to a lower edge of the flap 50. The regulation part 44 of the support member 41 and the second edge part 51B of the flap 50 have contact with each other and are sealed. The second edge part 51B of the flap 50 is located on an outer side of the regulation part 44 of the support member 41.

The ventilation apparatus 40 further includes the fastening member 90. The fastening member 90 fastens the support member 41 and the inner member 60. Fastening by the fastening member 90 enables rigid fixation or detachment. Pressure of holders 43C and 62C in clamping the detent 55B can be maintained. The fastening member 90 does not fasten the windshield 20 and the grommet 70. The fastening member 90 fastens the support member 41 and the inner member 60 in an inner side of the peripheral edge of the ventilation port 21.

Herein, three or more fastening members 90 fastening the support part 43 and the inner support part 62 is provided to surround holders 43C and 62C. Since the support part 43 and the inner support part 62 are firmly fastened, backlash of the flap 50 and the support part 43 can be easily suppressed when the flap 50 is angularly displaced.

Herein, the fastening member 90 is a self-threading screw. The self-threading screw can be fastened while a female screw is formed in the receiving part 49 when being fastened to the receiving part 49 in which the female screw is not previously formed. The self-threading screw is also referred to as a self-tapping screw in some cases. The fastening member 90 may be a screw other than the self-threading screw, and a female screw may be previously formed in the receiving part 49. The fastening member 90 may be a member other than a screw, but may also be a rivet, for example.

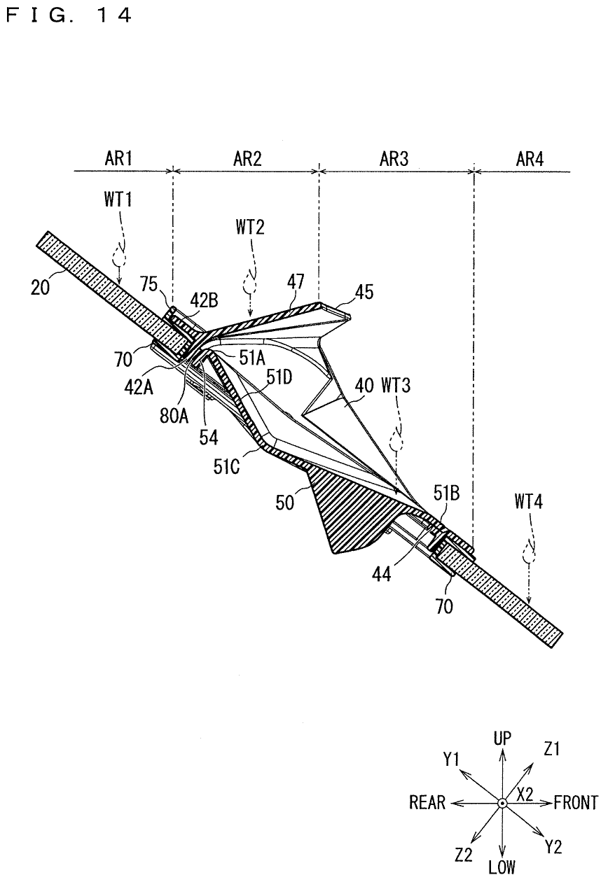

FIG. 14 is a diagram explaining an example of a flow of rainwater while the flap 50 is in the close posture CL. FIG. 14 illustrates ranges AR1 to AR4 in the front-back direction in the ventilation apparatus 40 and water WT1 to WT4 dropping on the wheeled vehicle 10 in each of the ranges AR1 to AR4.

In FIG. 14, the range ARI is a region located in back of the ventilation apparatus 40. The water WT1 dropping on the range ARI streams down the windshield 20 toward the ventilation apparatus 40. When the water WT1 streaming down the windshield 20 reaches the water stop wall 75 of the grommet 70, the water WT1 is guided by the water stop wall 75 in the X direction, and streams down a lateral side of the ventilation apparatus 40 and is guided in the Y2 direction. It is also considered that the water WT1 streaming down the windshield 20 passes over the water stop wall 75 and reaches the upper surface of the support member 41. Even in this case, since the protrusion part 45 is provided to the support member 41, suppressed is ingress of the water WT1 passing over the water stop wall 75 inside the wheeled vehicle 10. In this manner, the water WT1 hardly enters the inner side of the wheeled vehicle 10.

In FIG. 14, the range AR2 is a region from a front edge of the protrusion part 45 to a back end of the ventilation apparatus 40. The water WT2 dropping on the range AR2 streams down the upper surface 47 of the protrusion part 45 or the upper surface of the flange 42B, and is guided to a boundary part between the upper surface 47 of the protrusion part 45 and the upper surface of the flange 42B. The water WT2 collected in the boundary part between the upper surface 47 of the protrusion part 45 and the upper surface of the flange 42B is guided in the X direction along the boundary part, and streams down the lateral side of the protrusion part 45 and is guided in the Y2 direction. In this manner, the water WT2 hardly enters the inner side of the wheeled vehicle 10.

In FIG. 14, the range AR3 is a region from a front end of the ventilation apparatus 40 to the front edge of the protrusion part 45. The water WT3 dropping on the range AR3 streams down the body 51 of the flap 50 and is guided in the Y2 direction. Since the second edge part 51B of the flap 50 is located to be displaced in the Z1 direction with respect to the regulation part 44, the water WT3 hardly enters the inner side of the wheeled vehicle 10 from between the second edge part 51B of the flap 50 and the regulation part 44. In this manner, the water WT3 hardly enters the inner side of the wheeled vehicle 10.

In FIG. 14, the range AR4 is a region located in front of the front end of the ventilation apparatus 40. The water WT4 dropping on the range AR4 streams down the windshield 20 and is guided in the Y2 direction, and hardly reaches the ventilation port 21.

The rainwater is considered to drop on the wheeled vehicle 10 in the Z2 direction during traveling of the wheeled vehicle 10. Even in this case, since the protrusion part 45 is located in the Z1 direction with respect to the first edge part 51A of the flap 50, water hardly drops between the first edge part 51A of the flap 50 and the cylindrical part 42A of the frame part 42. The back side part 51D ranging from the first edge part 51A to the intermediate part 51C has a larger inclined angle than an inclined angle of the windshield 20 in the front surface of the flap 50. Thus, the water dropping on the back side part 51D hardly reaches the first edge part 51A of the flap 50 in the front surface of the flap 50. Since the seal member 80 is provided between the sidewall 53 and the upper wall 54 of the flap 50 and the cylindrical part 42A, water hardly enters the inner side of the wheeled vehicle 10 even when the water reaches between the sidewall 53 and the upper wall 54 of the flap 50 and the cylindrical part 42A.

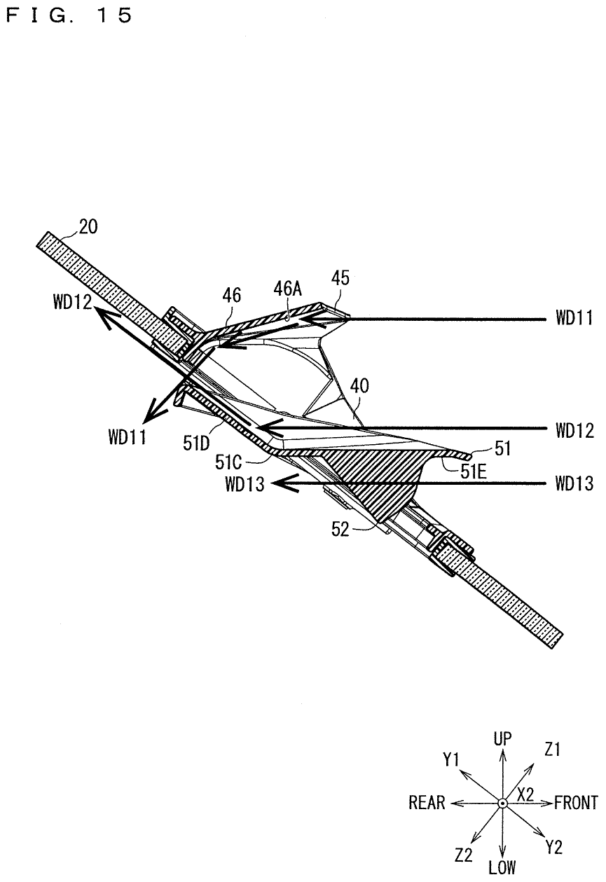

FIG. 15 is a diagram explaining an example of a flow of traveling wind while the flap 50 is in the first open posture OP1.

In the first open posture OP1, the back side part 51D of the body 51 of the flap 50 is disposed along the Y direction, and the front side part 51E is disposed along the front-back direction. For example, traveling wind WD11 is directed to the ventilation port 21 along the inclined surface 46A of the guiding part 46 of the protrusion part 45, and reaches the inner side of the wheeled vehicle 10 as it is. An upper edge of the inclined surface 46A is located on an upper side of the upper edge of the ventilation port 21 of the windshield 20. When there is no inclined surface 46A of the guiding part 46, the wind which does not reach the inner side of the wheeled vehicle 10 can be guided to the inner side of the wheeled vehicle 10 as the traveling wind WD11 by the inclined surface 46A of the guiding part 46. For example, traveling wind WD12 is directed to the ventilation port 21 along an outer surface of the front side part 51E and an outer surface of the back side part 51D, and reaches the inner side of the wheeled vehicle 10 as it is. The traveling wind WD12 flows along the inner surface of the windshield 20. The traveling wind WD12 can defog the windshield 20. The ventilation apparatus 40 in the first open posture OP1 has an excellent defogging function. For example, traveling wind WD13 is directed to the ventilation port 21 along a lower side of the front side part 51E, and reaches the inner side of the wheeled vehicle 10 as it is. Although FIG. 15 includes the knob 52 by reason that it illustrates a cross-sectional surface of the center of the flap 50 in the X direction, there is no knob 52 in a position slightly deviated to a side of the end part with respect to the center in the X direction; thus, the traveling wind WD13 can flow in such a manner.

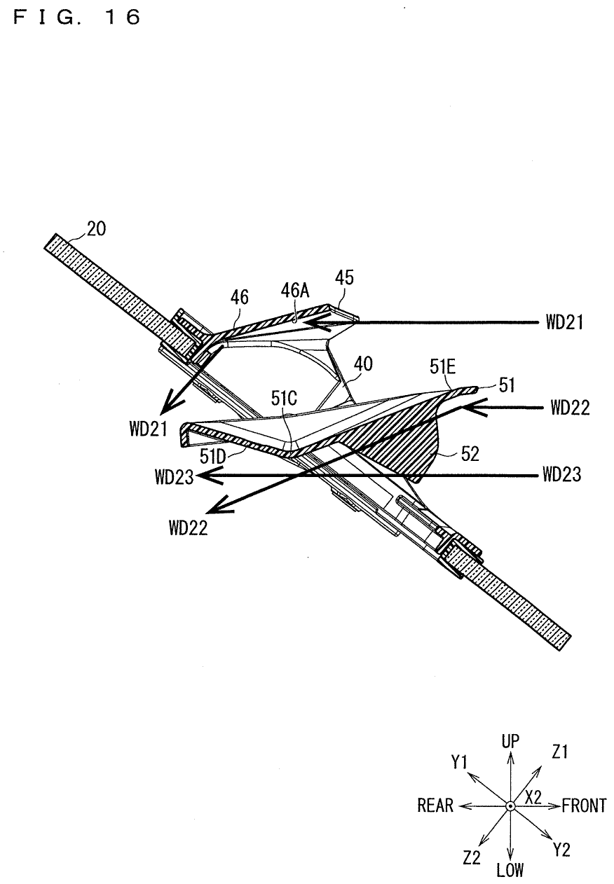

FIG. 16 is a diagram explaining an example of a flow of traveling wind while the flap 50 is in the second open posture OP2.

In the second open posture OP2, the intermediate part 51C is located on a lower side of the back side part 51D and the front side part 51E. For example, traveling wind WD21 is directed to the ventilation port 21 along the guiding part 46 of the protrusion part 45, and reaches the inner side of the wheeled vehicle 10 as it is. For example, traveling wind WD22 is directed to the ventilation port 21 along a lower surface of the front side part 51E, and reaches the inner side of the wheeled vehicle 10 as it is. For example, traveling wind WD23 is directed to the ventilation port 21 without being obstructed by the body 51 of the flap 50, and reaches the inner side of the wheeled vehicle 10 as it is. For example, when the ventilation apparatus 40 is provided to the first position Pl on a lower part of the windshield 20, the traveling wind WD23 is easily directed to an occupant. For example, when the ventilation apparatus 40 is provided to the second position P2 and the third position P3 on an upper part of the windshield 20, the traveling wind WD21 and WD22 is easily directed to an occupant.

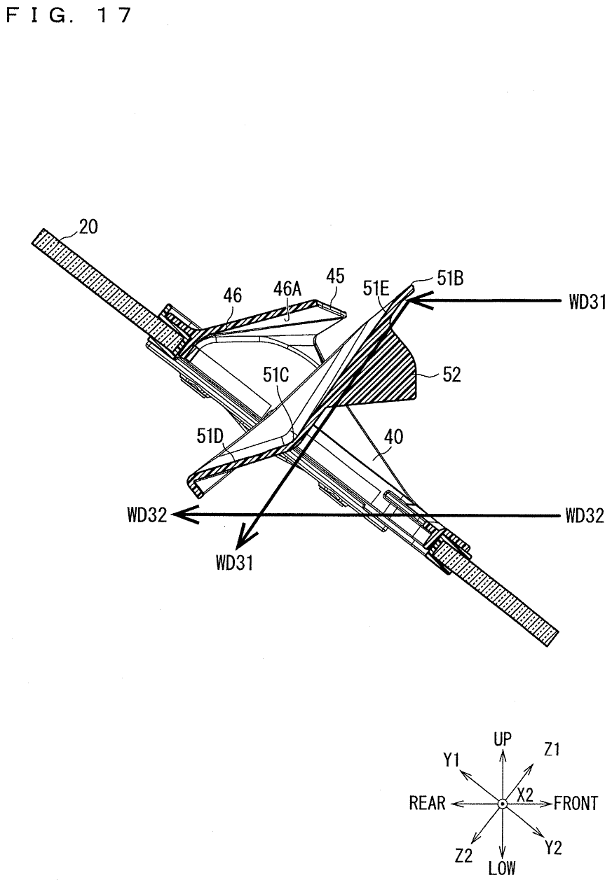

FIG. 17 is a diagram explaining an example of a flow of traveling wind while the flap 50 is in the third open posture OP3.

In the third open posture OP3, the front side part 51E, the intermediate part 51C, and the back side part 51D are located in this order from the upper side toward the lower side. The second edge part 51B of the body 51 of the flap 50 is located on an upper side of the front edge of the protrusion part 45. For example, traveling wind WD31 is directed to the ventilation port 21 along the lower side of the front side part 51E, and reaches the inner side of the wheeled vehicle 10 as it is. For example, traveling wind WD32 is directed to the ventilation port 21 without being obstructed by the body 51 of the flap 50, and reaches the inner side of the wheeled vehicle 10 as it is. For example, when the ventilation apparatus 40 is provided to the first position Pl on the lower part of the windshield 20, the traveling wind WD32 is easily directed to an occupant. For example, when the ventilation apparatus 40 is provided to the second position P2 and the third position P3 on the upper part of the windshield 20, the traveling wind WD31 is easily directed to an occupant. A projection area in the front-back direction of the body 51 in the third open posture OP3 is larger than that in the front-back direction of the body 51 in the second open posture OP2. An air volume of the traveling wind WD31 along the lower surface of the flap 50 tends to be larger than that of the traveling wind WD22.

### Effect Etc.

According to the ventilation apparatus 40 having the above configuration, the protrusion part 45 prevents rainwater streaming down the windshield 20 from being directed to the ventilation port 21. Accordingly, even when a gap is formed between the flap 50 and the windshield 20, ingress of rainwater inside the wheeled vehicle 10 through the gap can be suppressed.

The first support part 43L, the second support part 43R, and the protrusion part 45 are provided to one support member 41. Accordingly, the number of components constituting the ventilation apparatus 40 can be reduced.

The protrusion part 45 includes the guiding part 46 guiding the traveling wind WD11 and WD21 to the ventilation port 21. Accordingly, when the wheeled vehicle 10 travels while the gap is located between the flap 50 and the ventilation port 21, the traveling wind in a region larger than a front project area of the ventilation port 21 can be collected, and an air volume directed inside the wheeled vehicle 10 can be increased.

The protrusion part 45 includes the upper surface 47 extending to the front side from the portion facing the ventilation port 21 in proximity to the upper part of the ventilation port 21 and the side surface 48 extending to the front side from the portion facing the ventilation port 21 in proximity to both side parts of the ventilation port 21. The upper surface 47 and the side surface 48 on the right and left sides of the protrusion part 45 prevent the traveling wind from deviating from the ventilation port 21. Accordingly, an amount of air passing through the ventilation port 21 can be increased. Water streaming down the windshield 20 is hardly directed to the ventilation port 21 by the upper surface 47 and the side surface 48.

Provided is the inner member 60 sandwiching the windshield 20 from the inner side together with the support member 41 disposed on the outer side of the windshield 20. Since the support member 41 and the inner member 60 are provided, the ventilation apparatus 40 can be easily fixed to the windshield 20.

Also provided is the grommet 70 fitted into the peripheral edge part of the ventilation port 21, the support member 41 is formed into the frame-like shape extending around the peripheral edge part of the ventilation port 21, and the windshield 20 and the support member 41 sandwich the grommet 70. Accordingly, water hardly enters the vehicle interior through the gap between the windshield 20 and the support member 41.

The inner member 60 includes the first inner support part 62L sandwiching the first part 55L between the first inner support part 62L and the first support part 43L and the second inner support part 62R sandwiching the second part 55R between the second inner support part 62R and the second support part 43R. Achieved is the configuration that each end part is sandwiched between the support part 43 and the inner support part 62; thus, a configuration of rotatably supporting the end part can be simply formed.

The group of the first part 55L and the first support part 43L or the group of the second part 55R and the second support part 43R has the adjustment structure in which the open posture OP is adjusted to the optional posture in the postures. Accordingly, an amount of opening of the ventilation port 21 is easily adjusted.

The adjustment structure includes the shaft part 55 with the polygonal shape when seen from the axial direction, and the slit 56 is formed along the direction intersecting with the axial direction in the shaft part 55. Accordingly, each position corresponding to the plain surface of the polygonal shaft part 55 can be set to the position of the open posture OP; thus, moderation feeling can be easily obtained when the postures in the open posture OP are switched. The slit 56 is formed, thus the shaft part 55 is easily deformed in rotation, and increase of force applied in changing the posture of the flap 50 can be suppressed.

The flap 50 includes the body 51 covering the ventilation port 21 in the close posture CL and the knob 52 protruding from the body 51 toward the other side along the passage direction. Accordingly, an occupant in the vehicle can pinch the knob 52 and operate the flap 50; thus, an operation of opening and closing the flap 50 is easily performed.

In the X direction, the first part 55L is located in the first end part in the body 51, the second part 55R is located in the second end part in the body 51, and the knob 52 is located between the first end part and the second end part. Accordingly, a load occurring in operation of the knob 52 can be shared between the first part 55L and the second part 55R on both sides of the knob 52; thus, damage on the first part 55L and the second part 55R is easily suppressed.

The flap 50 includes the body 51 covering the ventilation port 21 in the close posture CL, the first sidewall 53L protruding from the first side edge 51FL of the body 51 along the passage direction (the Z direction), and the second sidewall 53R protruding from the second side edge 51FR of the body 51 along the passage direction. Accordingly, rigidity of the body 51 of the flap 50 can be increased by the first sidewall 53L and the second sidewall 53R.

The first part 55L is located on the outer surface of the first sidewall 53L, and the second part 55R is located on the outer surface of the second sidewall 53R. Accordingly, each of the base end part of the first part 55L and the base end part of the second part 55R can be provided to the planar part; thus, the first part 55L and the second part 55R can be increased in size. Accordingly, the flap 50 easily keeps each posture.

The flap 50 includes the body 51 covering the ventilation port 21 in the close posture CL, the body 51 includes the first edge part 51A located on the side of the protrusion part 45, the second edge part 51B located on the side opposite to the first edge part 51A, and the intermediate part 51C between the first edge part 51A and the second edge part 51B, and the intermediate part 51C protrudes to the other side with respect to each of the first edge part 51A and the second edge part 51B along the passage direction. Accordingly, when the wheeled vehicle 10 travels while the flap 50 is in the open posture OP1 with the small rotational angle, traveling wind can be easily guided to the peripheral edge of the ventilation port 21 in the windshield 20. Accordingly, the peripheral edge of the ventilation port 21 of the windshield 20 can be easily defogged. When the wheeled vehicle 10 travels while the flap 50 is in the open postures OP2 and OP3 with the large rotational angle, traveling wind can be easily guided to the occupant.

The wheeled vehicle 10 includes the ventilation apparatus 40 and the windshield 20 to which the ventilation apparatus 40 is attached. Accordingly, the wheeled vehicle 10 including the ventilation port 21 by which air ventilation can be performed and water hardly enters can be provided.

The windshield 20 is the windshield 20 located in front of an occupant space, and the protrusion part 45 is located in the upper part of the ventilation port 21 in the windshield 20. Accordingly, water streaming down the windshield 20 hardly enters the vehicle interior through the ventilation port 21.

The ventilation apparatus 40 includes the protrusion part 45 extending along the edge part of the ventilation port 21 on the side of the predetermined one direction and protruding from the windshield 20 to the outer side in the thickness direction. According to the ventilation apparatus 40, the protrusion part 45 prevents rainwater streaming down the windshield 20 from being directed to the ventilation port 21. Accordingly, even when the gap is formed between the flap 50 and the windshield 20, ingress of rainwater inside the wheeled vehicle 10 through the gap can be suppressed.

The protrusion part 45 covers an upper edge part of the ventilation port 21 from the upper side. Rainwater streaming from the upper side to the lower side of the ventilation port 21 is guided by the protrusion part 45, and moves away from the ventilation port 21. Accordingly, ingress of rainwater inside the wheeled vehicle 10 through the gap between the upper edge of the flap 50 and the ventilation port 21 can be suppressed.

This application discloses the following aspects.

A first aspect is a vehicle ventilation apparatus attached to a panel member including a ventilation port, including: a support member fixed around the ventilation port of the panel member; and a flap supported by the support member in an angularly displaceable form, wherein the flap is angularly displaced with respect to the support member, thus can change a posture between a close posture of closing the ventilation port and an open posture of opening the ventilation port, and the support member includes a first support part rotatably supporting a first part of the flap, a second support part rotatably supporting a second part of the flap, and a protrusion part protruding to one side along a passage direction of the ventilation port.

According to the vehicle ventilation apparatus, the protrusion part prevents rainwater streaming down the panel member from being directed to the ventilation port. Accordingly, even when the gap is formed between the flap and the panel member, ingress of rainwater inside the vehicle through the gap can be suppressed.

A second aspect is the vehicle ventilation apparatus according to the first aspect, wherein the first support part, the second support part, and the protrusion part are provided to one member.

Accordingly, the number of components constituting the vehicle ventilation apparatus can be reduced.

A third aspect is the vehicle ventilation apparatus according to the first or second aspect, wherein the protrusion part includes the guiding part guiding traveling wind to the ventilation port.

Accordingly, when the vehicle travels while the gap is located between the flap and the ventilation port, the traveling wind in the region larger than the front project area of the ventilation port can be collected, and the air volume directed inside the vehicle can be increased.

A fourth aspect is the vehicle ventilation apparatus according to any one of the first to third aspects, wherein the protrusion part includes an upper surface facing the ventilation port and extending to a front side from a portion in proximity to an upper part of the ventilation port and a side surface facing the ventilation port and extending to a front side from portions in proximity to both side parts of the ventilation port.

The upper surface and the side surface on the right and left sides of the protrusion part prevent the traveling wind from deviating from the ventilation port. Accordingly, the amount of air passing through the ventilation port can be increased.

A fifth aspect is the vehicle ventilation apparatus according to any one of the first to fourth aspects, wherein the protrusion part includes a guiding part guiding traveling wind to the ventilation port, an upper surface facing the ventilation port and extending to a front side from a portion in proximity to an upper part of the ventilation port, and a side surface facing the ventilation port and extending to a front side from portions in proximity to both side parts of the ventilation port.

Accordingly, when the vehicle travels while the gap is located between the flap and the ventilation port, the traveling wind in the region larger than the front project area of the ventilation port can be collected, and the air volume directed inside the vehicle can be increased. The upper surface and the side surface on the right and left sides of the protrusion part prevent the traveling wind from deviating from the ventilation port. Accordingly, the amount of air passing through the ventilation port can be increased.

A sixth aspect is the vehicle ventilation apparatus according to any one of the first to fifth aspects further includes an inner member sandwiching the panel member from inside together with the support member disposed outside the panel member.

The support member and the inner member are provided, thus the ventilation apparatus is easily fixed to the panel member.

A seventh aspect is the vehicle ventilation apparatus according to the sixth aspect includes a grommet fitted into a peripheral edge part of the ventilation port, the support member is formed into a frame-like shape extending around the peripheral edge part of the ventilation port, and the panel member and the support member sandwich the grommet.

Accordingly, water hardly enters the vehicle interior through the ventilation port.

An eighth aspect is the vehicle ventilation apparatus according to the sixth or seventh aspect, wherein the inner member includes a first inner support part sandwiching the first part between the first inner support part and the first support part and a second inner support part sandwiching the second part between the second inner support part and the second support part.

Achieved is the configuration that each end part is sandwiched between the support part and the inner support part; thus, a configuration of rotatably supporting the end part can be simply formed.

A ninth aspect is the vehicle ventilation apparatus according to any one of the first to eighth aspects, wherein a group of the first part and the first support part or a group of the second part and the second support part has an adjustment structure of adjusting the open posture to an optional posture in postures.

Accordingly, an amount of opening of the ventilation port is easily adjusted.

A tenth aspect is the vehicle ventilation apparatus according to the ninth aspect, wherein the adjustment structure includes a shaft part having a polygonal shape when seen from an axial direction, and a slit is formed along a direction intersecting with the axial direction in the shaft part.

Accordingly, each position corresponding to the plain surface of the polygonal shaft part can be set to the position of the open posture, thus moderation feeling can be easily obtained when the postures in the open posture are switched. The slit is formed; thus, the shaft part is easily deformed in rotation, and increase of force applied in changing the posture of the flap can be suppressed.

An eleventh aspect is the vehicle ventilation apparatus according to any one of the first to tenth aspects, wherein the flap includes a body covering the ventilation port in the close posture and a knob protruding from the body toward another side along the passage direction.

Accordingly, the occupant in the vehicle can pinch the knob and operate the flap; thus, the operation of opening and closing the flap is easily performed.

A twelfth aspect is the vehicle ventilation apparatus according to the eleventh aspect, wherein the first part is located in a first end part in the body, the second part is located in a second end part in the body, and the knob is located between the first end part and the second end part in the body.

Accordingly, a load occurring in operation of the knob can be shared between the first part and the second part, thus damage on the first part and the second part is easily suppressed.

A thirteenth aspect is the vehicle ventilation apparatus according to any one of the first to twelfth aspects, wherein the flap includes a body covering the ventilation port in the close posture, a first sidewall protruding from a first side edge of the body along the passage direction, and a second sidewall protruding from a second side edge of the body along the passage direction.

Accordingly, rigidity of the body of the flap can be increased by the first sidewall and the second sidewall.

A fourteenth aspect is the vehicle ventilation apparatus according to the thirteenth aspect, wherein the first part is located in an outer surface of the first sidewall, and the second part is located in an outer surface of the second sidewall.

Accordingly, each of the base end part of the first part and the base end part of the second part can be provided to the planar part; thus, the first part and the second part can be increased in size.

A fifteenth aspect is the vehicle ventilation apparatus according to any one of the first to fourteenth aspects, wherein the flap includes a body covering the ventilation port in the close posture, the body includes a first edge part located on a side of the protrusion part, a second edge part located on a side opposite to the first edge part, and an intermediate part between the first edge part and the second edge part, and the intermediate part protrudes to another side more than each of the first edge part and the second edge part along the passage direction.

Accordingly, when the vehicle travels while the flap is in the open posture with the small rotational angle, traveling wind can be easily guided to the peripheral edge of the ventilation port in the panel member. Accordingly, the peripheral edge of the ventilation port of the panel member can be easily defogged. When the vehicle travels while the flap is in the open posture with the large rotational angle, traveling wind can be easily guided to the occupant.

A sixteenth aspect is a vehicle including the vehicle ventilation apparatus according to any one of the first to fifteenth aspects; and a panel member to which the vehicle ventilation apparatus is attached.

Accordingly, the vehicle including the ventilation port by which air ventilation can be performed and water hardly enters can be provided.

A seventeenth aspect is the vehicle according to the sixteenth aspect, wherein the panel member is a windshield located in front of an occupant space, and the protrusion part is located on an upper part of the windshield.

Accordingly, water streaming down the windshield hardly enters the vehicle interior through the ventilation port.

An eighteenth aspect is the vehicle ventilation apparatus attached to a panel member including a ventilation port passing in a thickness direction, including: a support member disposed on a surrounding part of the ventilation port of the panel member; the flap which is supported by the support member in an angularly displaceable form and can change a posture between a close posture of closing the ventilation port and an open posture of opening the ventilation port; and a protrusion part extending along an edge part of the ventilation port on a side of predetermined one direction and protruding from the panel member to an outer side in a thickness direction.

The protrusion part prevents rainwater streaming down the panel member from being directed to the ventilation port. Accordingly, even when the gap is formed between the flap and the panel member, ingress of rainwater inside the vehicle through the gap can be suppressed.

A nineteenth aspect is the vehicle ventilation apparatus according to the eighteenth aspect, wherein the protrusion part covers an upper edge part of the ventilation port from an upper side.

Rainwater streaming from the upper side to the lower side of the ventilation port is guided by the protrusion part, and moves away from the ventilation port. Accordingly, ingress of rainwater inside the vehicle through the gap between the upper edge of the flap and the ventilation port can be suppressed.

The foregoing description is in all aspects illustrative and does not restrict the present invention. Numerous modifications and variations that have not yet been exemplified are devised without departing from the scope of the present invention.

1. A vehicle ventilation apparatus attached to a panel member including a ventilation port, comprising:
a support member fixed around the ventilation port of the panel member; and
a flap supported by the support member in an angularly displaceable form, wherein
the flap is angularly displaced with respect to the support member, thus can change a posture between a close posture of closing the ventilation port and an open posture of opening the ventilation port, and
the support member includes a first support part rotatably supporting a first part of the flap, a second support part rotatably supporting a second part of the flap, and a protrusion part protruding to one side along a passage direction of the ventilation port.

2. The vehicle ventilation apparatus according to claim 1, wherein
the first support part, the second support part, and the protrusion part are provided to one member.

3. The vehicle ventilation apparatus according to claim 1, wherein
the protrusion part includes a guiding part guiding traveling wind to the ventilation port.

4. The vehicle ventilation apparatus according to claim 1, wherein
the protrusion part includes an upper surface facing the ventilation port and extending to a front side from a portion in proximity to an upper part of the ventilation port and a side surface facing the ventilation port and extending to a front side from portions in proximity to both side parts of the ventilation port.

5. The vehicle ventilation apparatus according to claim 1, wherein
the protrusion part includes a guiding part guiding traveling wind to the ventilation port, an upper surface facing the ventilation port and extending to a front side from a portion in proximity to an upper part of the ventilation port, and a side surface facing the ventilation port and extending to a front side from portions in proximity to both side parts of the ventilation port.

6. The vehicle ventilation apparatus according to claim 1, comprising
an inner member sandwiching the panel member from inside together with the support member disposed outside the panel member.

7. The vehicle ventilation apparatus according to claim 6, comprising
a grommet fitted into a peripheral edge part of the ventilation port, wherein
the support member is formed into a frame-like shape extending around the peripheral edge part of the ventilation port, and
the panel member and the support member sandwich the grommet.

8. The vehicle ventilation apparatus according to claim 6, wherein
the inner member includes a first inner support part sandwiching the first part between the first inner support part and the first support part and a second inner support part sandwiching the second part between the second inner support part and the second support part.

9. The vehicle ventilation apparatus according to claim 1, wherein
a group of the first part and the first support part or a group of the second part and the second support part has an adjustment structure of adjusting the open posture to an optional posture in postures.

10. The vehicle ventilation apparatus according to claim 9, wherein
the adjustment structure includes a shaft part having a polygonal shape when seen from an axial direction, and
a slit is formed along a direction intersecting with the axial direction in the shaft part.

11. The vehicle ventilation apparatus according to claim 1, wherein
the flap includes a body covering the ventilation port in the close posture and a knob protruding from the body toward another side along the passage direction.

12. The vehicle ventilation apparatus according to claim 11, wherein
the first part is located in a first end part in the body, the second part is located in a second end part in the body, and the knob is located between the first end part and the second end part in the body.

13. The vehicle ventilation apparatus according to claim 1, wherein
the flap includes a body covering the ventilation port in the close posture, a first sidewall protruding from a first side edge of the body along the passage direction, and a second sidewall protruding from a second side edge of the body along the passage direction.

14. The vehicle ventilation apparatus according to claim 13, wherein
the first part is located in an outer surface of the first sidewall, and the second part is located in an outer surface of the second sidewall.

15. The vehicle ventilation apparatus according to claim 1, wherein
the flap includes a body covering the ventilation port in the close posture,
the body includes a first edge part located on a side of the protrusion part, a second edge part located on a side opposite to the first edge part, and an intermediate part between the first edge part and the second edge part, and
the intermediate part protrudes to another side more than each of the first edge part and the second edge part along the passage direction.

16. A vehicle, comprising:
the vehicle ventilation apparatus according to claim 1; and
a panel member to which the vehicle ventilation apparatus is attached.

17. The vehicle according to claim 16, wherein
the panel member is a windshield located in front of an occupant space, and
the protrusion part is located on an upper part of the windshield.

18. A vehicle ventilation apparatus attached to a panel member including a ventilation port passing in a thickness direction, comprising:
a support member disposed on a surrounding part of the ventilation port of the panel member;
the flap which is supported by the support member in an angularly displaceable form and can change a posture between a close posture of closing the ventilation port and an open posture of opening the ventilation port; and
a protrusion part extending along an edge part of the ventilation port on a side of predetermined one direction and protruding from the panel member to an outer side in a thickness direction.

19. The vehicle ventilation apparatus according to claim 18, wherein the protrusion part covers an upper edge part of the ventilation port from an upper side.
